(19) United States
(12) Patent Application Publication
(10) Pub. No.: US 2026/0297981 A1
(43) Pub. Date: Oct. 1, 2026

(54) STRIKE-PLATE POWERED MORTISE LOCK

(71) Applicant: Command Access Technology, Inc., Yorba, CA (US)

(72) Inventors: Lutz Mueller, Glendale, CA (US); Parssa Sabouhi, Corona, CA (US); Matt Dwelley, Wildomar, CA (US)

(73) Assignee: Command Access Technology, Inc., Yorba Linda, CA (US)

(21) Appl. No.: 19/570,651

(22) Filed: Mar. 18, 2026

Related U.S. Application Data
(60) Provisional application No. 63/781,119, filed on Mar. 31, 2025.

(51) Int. Cl. E05B 47/00; E05B 63/08

(52) U.S. Cl. CPC E05B 47/0012; E05B 47/0002; E05B 63/08; E05B 2047/0016; E05B 2047/002; E05B 2047/0059

(57) ABSTRACT

An electrified lock system, including a mortise lock with an electrically powered device, a latch bolt and a drive linkage coupling the device to a linkage configured to lock a lever or knob spindle from retracting the latch bolt in an extended neutral position or to allow the latch bolt to be retracted to allow the door to open. The lock includes an electrical contact coupler system to transfer power and control signals between the strike plate of a door frame to the lock. A retraction linkage synchronizes the movement of the coupler system with the latch bolt retraction; when the latch bolt retracts, the coupler system follows suit, retracting into the mortise lock body. A strike plate electrical contact set is within a recess within the door to make electrical contact with the lock coupler system, the electrical contact set connected to an access controller and power supply.

### BACKGROUND OF THE APPLICATION AND INVENTION

This application claims priority to provisional Application Number 63/781,119, filed Mar. 31, 2025. The entire contents of the application is incorporated herein by this reference.

Current electrified locking systems typically receive power through the hinge side of the door using electrified transfer hinges and coring of raceways within the door to route wires. This method is complex, expensive, and prone to failures at the hinge transfer point. Additionally, coring a door can compromise its fire rating if not performed by certified professionals, making the installation process challenging and limiting the installer base.

### BRIEF DESCRIPTION OF DRAWINGS

Features and advantages of the disclosure will readily be appreciated by persons skilled in the art from the following detailed description when read in conjunction with the drawing wherein:

FIG. 1 diagrammatically illustrates an exemplary embodiment of a mortise lock in accordance with aspects of the invention, as in place in a door cutout (not shown) in relation to an exemplary embodiment of a strike plate assembly. FIG. 1A is an enlarged view of the area within circle A in FIG. 1.

FIG. 2 is an isometric view of the mortise lock 100 with the top cover plate removed, and with components including connector assembly 200 in exploded view.

FIG. 3 is a view similar to FIG. 2, but with the connector assembly components shown in assembled form within the chassis of the lock.

FIGS. 4, 5A and 5B are diagrammatic top views of portions of the lock of FIG. 1 with the cover plate removed.

FIG. 6A is an isometric view of an exemplary embodiment of a strike plate assembly usable with the mortise lock of FIG. 1. FIG. 6B is an exploded view of the strike plate assembly of FIG. 6A.

FIGS. 7A, 7B, 7C and 7D are diagrammatic isometric views of the lock of FIG. 1 with the cover plate removed. FIGS. 7A and 7B show the lock in the normal position, with the connector unit assembly in the fully extended position and the latch bolt in the normal extended (lock) position, with FIG. 7B showing the connector unit assembly in cutaway view. FIGS. 7C and 7D show the lock in the unlocked configuration with the latch bolt depressed and the connector unit assembly in the withdrawn position, with FIG. 7D showing the connector unit assembly in cutaway view. FIGS. 7E and 7F are views similar to FIGS. 7A and 7B, respectively, but with the door in which the lock 100 is mounted, closed and showing the engagement of the latch bolt assembly and the connector unit 210 with the strike plate assembly.

FIG. 8 is a schematic diagram illustrative of an exemplary embodiment of the electrical wiring carrying DC power and access control signals for the mortise lock of FIG. 1 and the connection between the strike plate system and the mortise lock.

### DETAILED DESCRIPTION OF THE INVENTION

To address the issues with providing electrical power through the hinge side of the door, a strike-side powered lock is described that eliminates the need for door coring and hinge wire routing. By drawing power from the strike side of the door frame, the disclosed lock solution significantly reduces installation complexity and costs while enhancing overall system reliability. This breakthrough technology not only simplifies installation but also opens the market to a wider range of installers, making electrified locking more accessible and practical.

An exemplary embodiment of this invention involves an electrical contact coupler system configured to transfer low-voltage power (<40VDC) and control signals from the strike plate of a door frame to a motorized mortise lock. This system features a novel retraction linkage and spring mechanism housed within the mortise lock body, which synchronizes the movement of the electrical contact coupler system with the latch bolt's retraction.

When the mortise lock's latch bolt retracts, whether by lever operation or door closure, the electrical contact coupler follows suit, retracting into the mortise lock body. This synchronized motion prevents collisions and abrasions with the strike plate, ensuring the integrity and longevity of the electrical contacts throughout the lock's operational life.

In an exemplary embodiment, the electrical contact coupler includes four contact points:
Two contacts deliver <40VDC power.
Two contacts are connected to a “request-to-exit” switch to monitor the inside lever position.

In an exemplary embodiment, the contact coupler system includes spring-loaded electrical contacts within the mortise lock and static electrical pads mounted on a PCB (printed circuit board) within the strike plate assembly. The spring-loaded design ensures that when the latch bolt is extended, the contacts can compress against spring pressure, maintaining a secure electrical connection with the static electrical pads within the strike plate.

In an exemplary embodiment, this entire mechanism is integrated within the mortise lock body and the dust box housing of the strike plate, requiring no additional space beyond standard cutouts. As a result, the system is fully compatible with retrofits and standard door preparations, making it ideal for seamless upgrades.

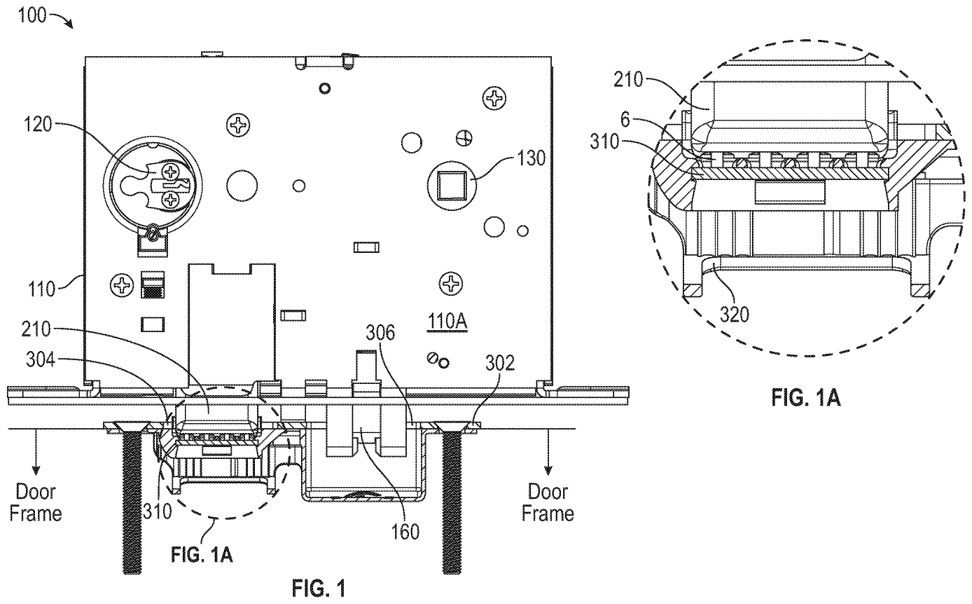

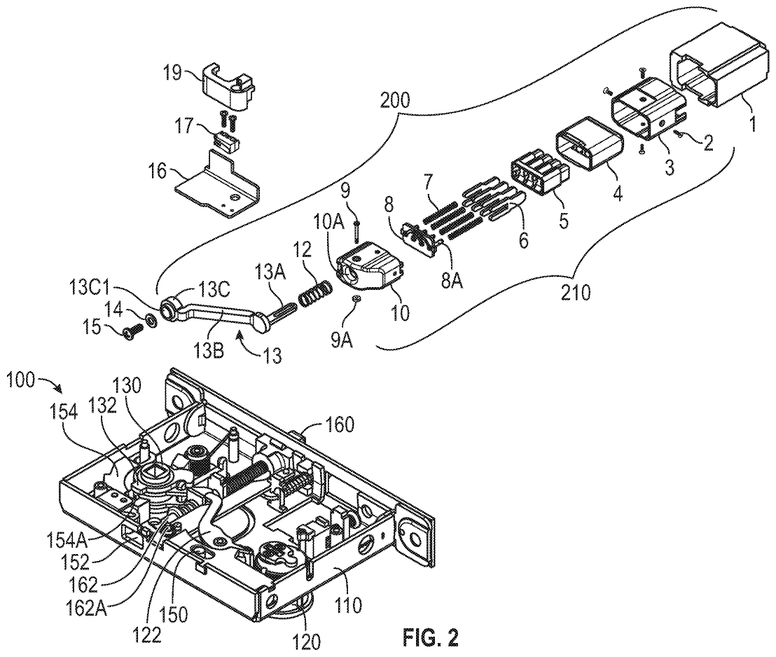

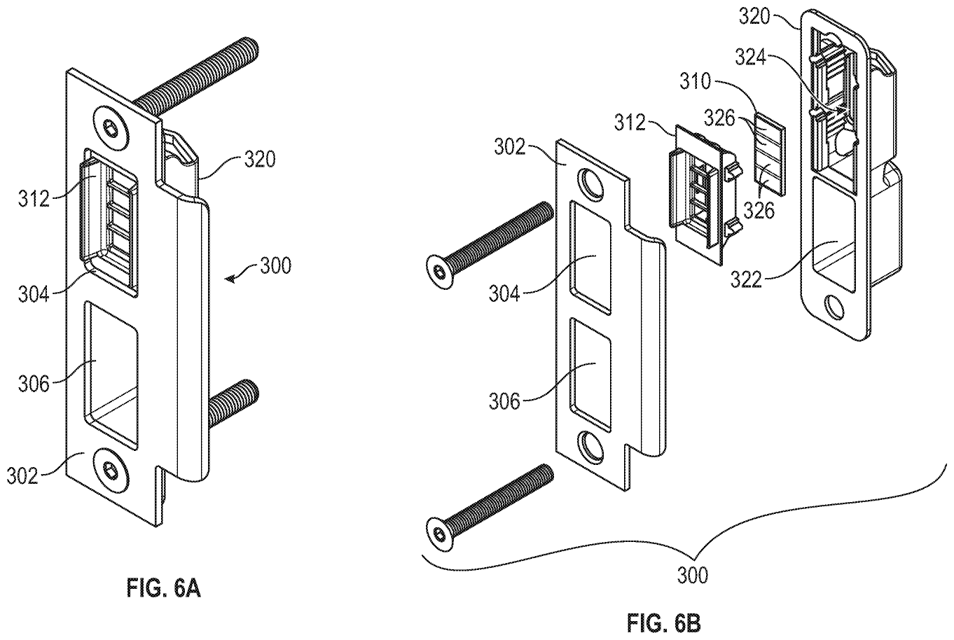

Referring now to FIGS. 1-8 , an exemplary embodiment of the strike-plate powered mortise lock is illustrated. FIGS. 1 and 1A diagrammatically illustrate the mortise lock 100 as in place in a door cutout (not shown) in relation to the strike plate assembly 300. The mortise lock includes a structural chassis 110 in which the lock components are mounted, with a chassis top cover plate 110A. In the conventional manner, the mortise lock 100 includes a key cylinder 120 for operating the lock with a key, and a lever spindle 130 for connection to a lever (not shown) for operating the lock. Typically the lock will allow connection of respective door levers on both the inside and outside of the door. Lock 100 includes a latch bolt assembly 160 shown in a locked position within the latch opening 302 of the strike plate 304. The lock 100 includes an electrical contact coupler system 200 (FIG. 2) which in FIG. 1 has electrical contacts 6 (FIGS. 1A, 2) extending into contact with the static electrical contacts 326 (FIG. 6B) on strike plate PCB 310.

FIG. 1A is an enlarged view of the area within circle A in FIG. 1.

FIG. 2 is an isometric view of the mortise lock 100 with the top cover plate removed, and with components including connector assembly 200 in exploded view. The components shown in assembled condition within the chassis 110 in FIG. 2 are generally similar to components in a known mortise lock electrically powered in the conventional manner through the electrified transfer hinges and door raceways. These components include the key cylinder 120, spindle 130 for attachment to a lever or knob (not shown), and latch bolt assembly 160, as well as electrically powered device 150, which in one embodiment is a motor and gear train to convert rotary motion into linear motion, or in another embodiment a solenoid. Rotating the spindle causes cog 134 carried by the spindle to engage and retract the latch bolt assembly. The device 150 drives a link 152 which in turn moves locking device 154 between a lock position in which lock recess 154A is moved into engagement with tang 132 of the spindle, locking the position of the spindle 130 (and connected outside lever), keeping the lever from activating and retracting the latch bolt. The device 150 is configured to slide the link 152 to move the locking device so that the recess is out of engagement with the tang 132, allowing movement of the lever or knob and connected spindle. The electrical device and link 152 locks the spindle and lever or knob, providing lever or knob control. The lever or knob when turned can retract the latch bolt, but the latch bolt can also retract independent of the lever. For example, the lever or knob can be locked and static and the latch bolt can be pushed into a retracted position by the strike plate when a door is closing. The structure and operation of the lock elements discussed in this paragraph is similar to existing mortise lock systems known in the art, which are powered by electrified hinges and wiring passed through raceways formed through the door to the mortise lock. The locking of the spindle 130 typically applies only to the outside lever or knob, and the inside door lever or knob may always be allowed to open the door from the inside. Since this function of the lock is known, it is not described in further detail.

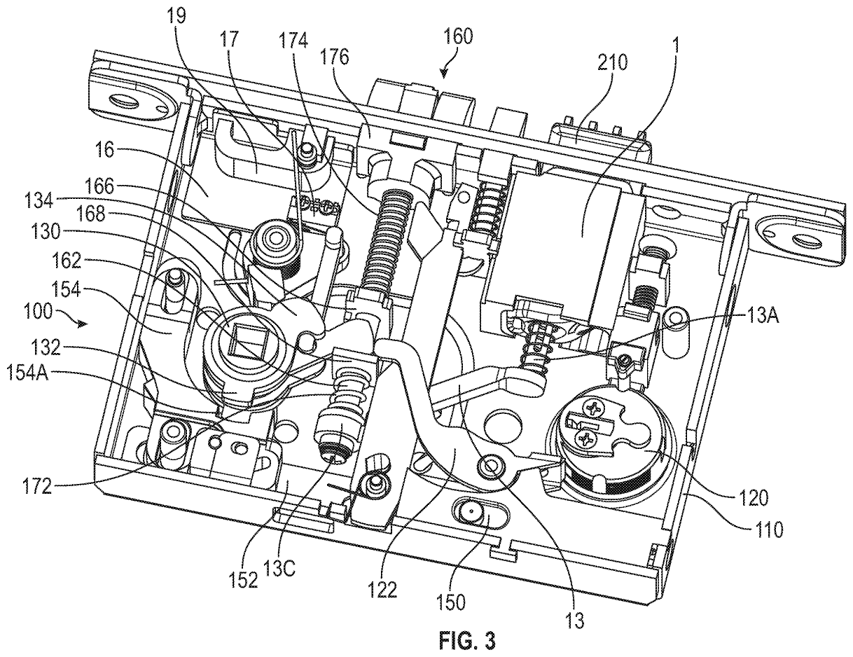

FIG. 3 is similar to FIG. 2, but with the connector assembly 200 components shown in assembled form within the chassis 110 of lock 100.

Instead of receiving electrical power through the door hinge, the lock 100 is configured to receive electrical power through connector assembly 200 and the PCB 310 of the strike plate assembly 300.

Referring again to the exploded view in FIG. 2, the contact coupler system 200 includes connector main housing 1, slide adjustment bracket 3, four position lock slide contact 4, four position pin holder 5 and PCB holder 10, to which is attached by tab protrusions the PCB 8. The coupler system further includes four electrical connector pins 6, fabricated of an electrically conductive material such as copper, and four compression springs 7 which are fitted between the PCB 8 with protruding pins 8A and slots in the connector pins 6. The respective bracket 3, pin holder 5 and PCB holder 10 are assembled together with screws 2, 9, nut 9B or other fastening means such as adhesive or the like to form a unit assembly 210 which is slidingly received within main housing 1.

The four compression springs 7 provide independent biasing forces to the connector pins 6 to ensure each pin makes good electric contact with the static electrical contacts on strike plate PCB 310 with the door closed and the latch bolt is in locked position within the strike plate.

Still referring to FIG. 2, the contact coupler system 200 includes coupler connection arm 13 and compression spring 12. The arm 13 includes a tip portion 13A onto which the spring 12 is mounted, and which is configured to extend into opening 10A of holder 10. The arm 13 includes connection portion 13B between the tip portion 13A and distal end 13C, which has opening 13C1 formed therein. The distal end is configured for attachment to a threaded opening 162A formed in the distal end of latch rod 162. A threaded fastener 15 and washer 14 secure the distal end of the connection arm to the latch rod, so that the connection arm moves with the latch rod and latch bolt assembly 160. The connection portion 13B provides an angular offset between the tip portion 13A and distal portion 13C. The spring 12 allows the unit assembly 210 to translate along the axis of tip portion 13A within the connector main housing 1.

FIG. 2 also shows “request-to-exit” (REX) switch 17, with mounting bracket 16 and bushing 19 in exploded view. The REX switch is activated only by inside lever movement to open the door in this exemplary embodiment.

FIG. 3 shows the REX switch 17 in assembled view, with mount 16 and bushing 19. The latch rod 162 passes through an opening in stationary bracket 166 which is fixed to the floor of the chassis. A compression spring 174 is fitted onto the rod between the fixed bracket 166 and latch bolt fitting 176 to urge the latch bolt into the neutral, latched position. The rod 162 also has a bracket 168 affixed to the rod with a compression spring 172 fitted between the bracket 168 and the distal end 13C of the connection arm 13. The spring 172 also tends to urge the latch bolt into the neutral position.

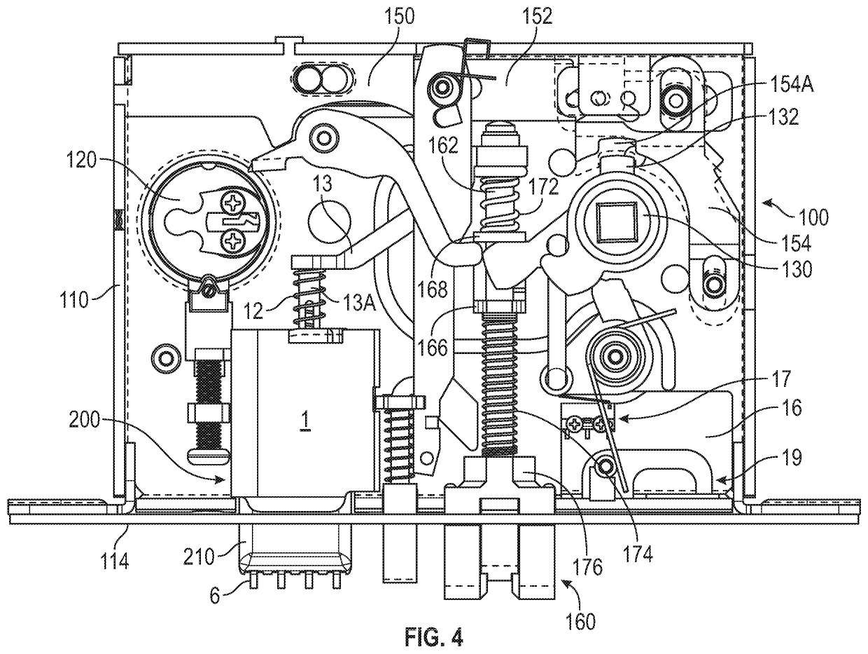

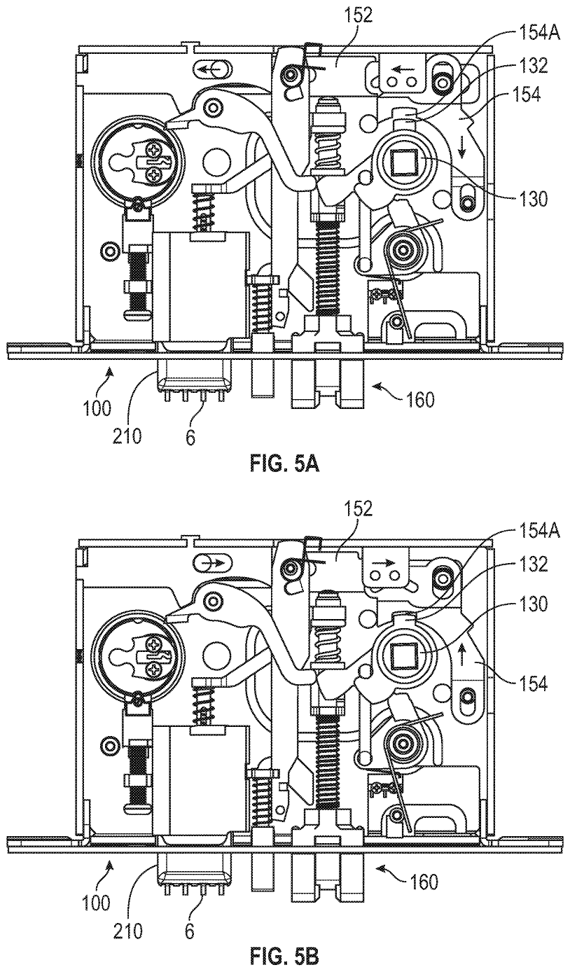

FIGS. 4, 5A and 5B are diagrammatic top views of portions of the lock 100 with the cover plate removed. FIG. 4 shows the connector assembly 200 with the sliding assembly in the normal position with the unit assembly 210 and connector pins in the fully extended position through chassis front plate 114. The motor drive elements are shown with the locking device 154 in the unlocked position with recess 154A out of engagement with tang 132 of the spindle 130. The locked position of the locking device 154 is shown in phantom line in FIG. 4.

FIGS. 5A and 5B show the different positions of the locking device 154, with FIG. 5A showing the unlocked position, and FIG. 5B showing the locked position. In FIGS. 5A and 5B, the latch bolt assembly 160 is in the neutral position (locked), and the connector unit assembly 210 is in the fully extended configuration for the pins 6 to make electrical contact with the strike plate PCB 310 (not shown in FIGS. 5A and 5B). The motor 150 only provides lever control, to lock the lever spindle 130 from rotation by moving locking device 154 with recess 1554A into engagement with tang 132.

FIG. 6A is a diagrammatic isometric view illustrating the strike plate assembly 300 in assembled condition, with FIG. 6B illustrating the assembly in exploded view. The assembly 300 includes the strike plate 302, with openings 304 and 306 formed therein as shown. A plastic dust box 320 is configured to be assembled to the strike plate in a sandwiched position on the door frame. The dust box has receptacles 322 and 324, with receptacle 322 sized to receive the latch bolt. Receptacle 324 is fitted with a PCB holder 312 which mounts the PCB 310. Wiring (not shown in FIGS. 6A, 6B) connects the PCB contacts 326 to the access control power supply and the access controller.

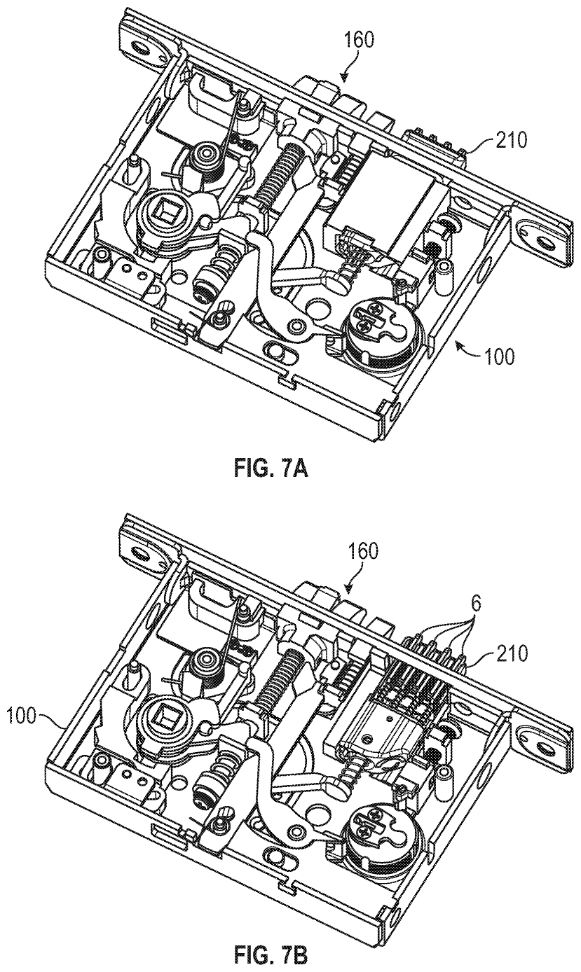

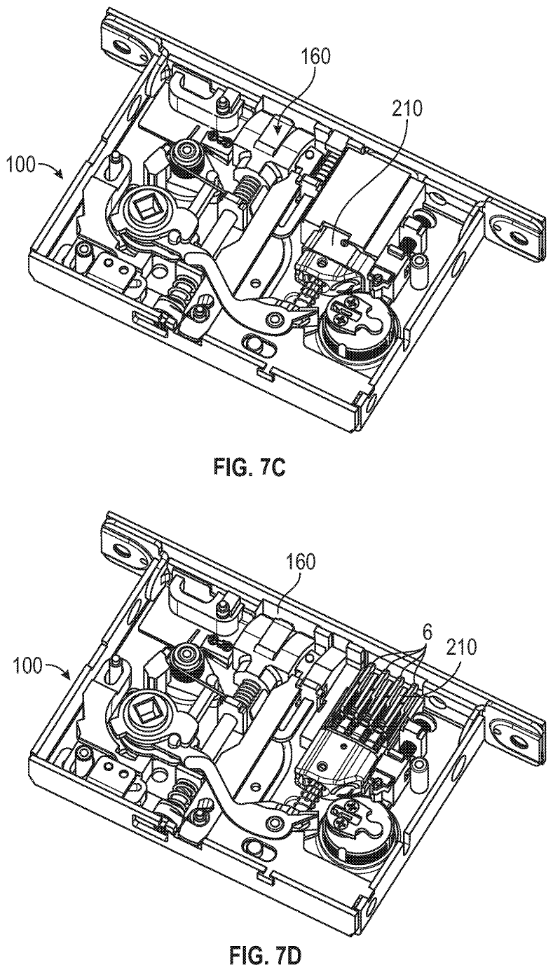

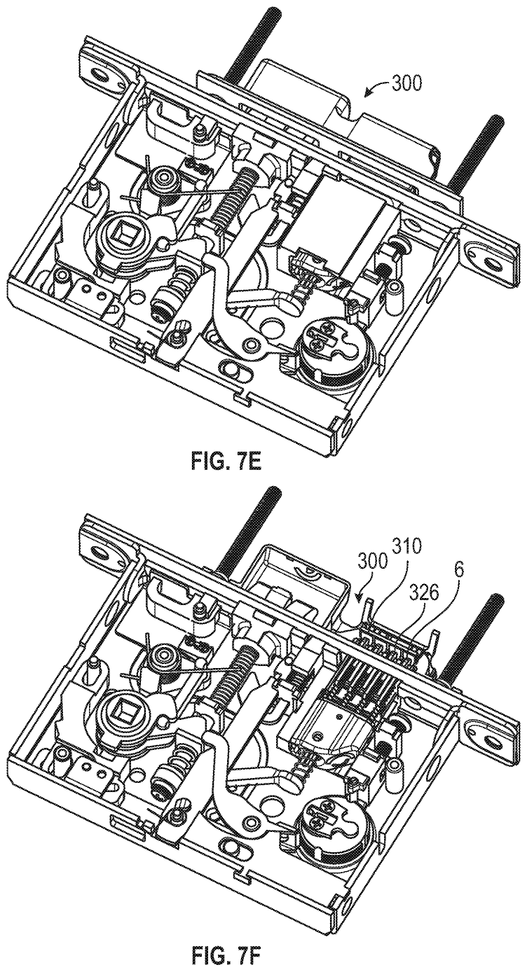

FIGS. 7A, 7B, 7C and 7D are diagrammatic isometric views of the lock 100 with the cover plate 110 removed. FIGS. 7A and 7B show the lock in the normal position, with the connector unit assembly 210 in the fully extended position and the latch bolt in the normal extended (neutral) position, with FIG. 7B showing the connector unit assembly 210 in cutaway view showing the connector pins 6. The sliding lock feature is not engaged with tang 132. FIGS. 7C and 7D show the lock in the unlocked configuration with the latch bolt depressed and the connector unit assembly 210 in the withdrawn position, with FIG. 7D showing the connector unit assembly 210 in cutaway view showing the connector pins 6. FIGS. 7E and 7F are views similar to FIGS. 7A and 7B, respectively, but in the condition with the door in which the lock 100 is mounted, closed and showing the engagement of the latch bolt assembly and the connector unit 210 with the strike plate assembly. The pins 6 of the connector unit 210 are in engagement with contact pads 326 on the static PCB 310.

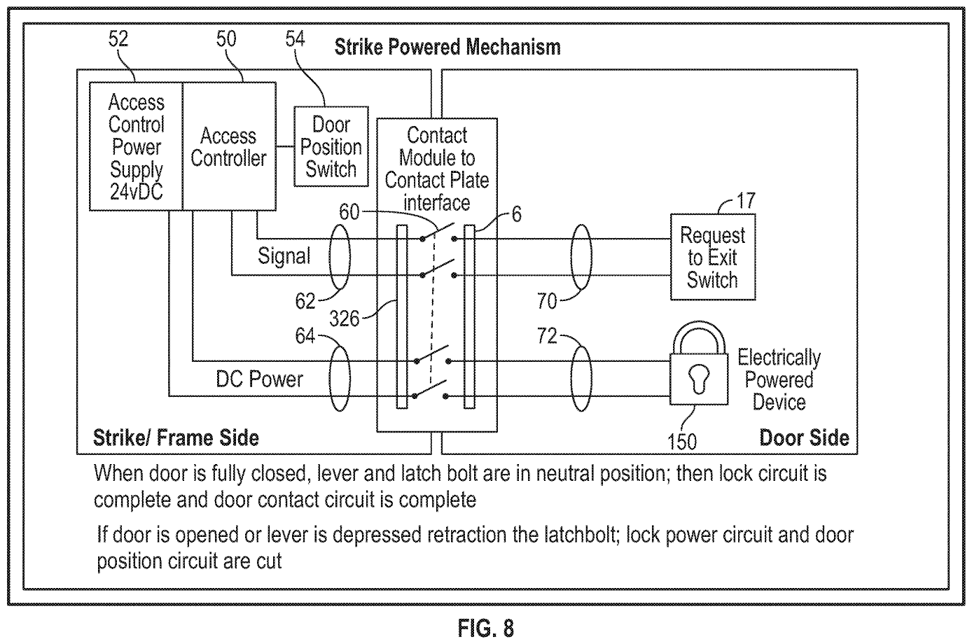

FIG. 8 is a schematic diagram illustrative of an exemplary embodiment of the electrical wiring carrying DC power and access control signals for the mortise lock 100 and the connection between the strike plate system and the mortise lock. The ganged set 60 of four switches represent the connection/disconnection between the electrical connection pins 6 of the connector unit assembly 210 and the contacts 326 on the static PCB 310 in the strike plate assembly. When contact is made, the REX switch 17 is connected by signal lines 62 and 70 to the access controller 50, and the electrically powered device 150 is connected to the access control power supply 52 by wires 72 in the lock and wires 64 on the strike frame side. The access controller also receives a door position signal from door position switch 54, in the conventional manner.

When the door is fully closed, the lever and latch bolt are in the neutral position, i.e. the lever is horizontal and the latch bolt and connector unit assembly 210 are fully extended into the strike plate recesses. In this condition, the lock mechanism is in engagement with tang 132 to lock the spindle from rotation. The lock circuit and door contact circuits are complete, and typically, the access controller 50 deactivates the power supply 52. In this embodiment, the REX switch is a normally open switch that when triggered will close the circuit monitored by the access controller 50. The access controller will look for the closed circuit to register it as a “Request to Exit.” If the door is opened by the inside lever is depressed, the REX switch 17 is closed, notifying the access controller 50 that a “Request to “Exit” trigger has been registered. A REX trigger when combined with an open-door signal from the door position sensor 54 establishes an authorized access (entry or exit). An open door without a corresponding REX signal or a “Request to Enter” from a separate signal (e.g. key card badge swipe) can be considered a fault or a forced entry.

Although the foregoing has been a description and illustration of specific embodiments of the subject matter, various modifications and changes thereto can be made by persons skilled in the art without departing from the scope and spirit of the invention.

1. A strike-plate-powered electrified mortise lock system comprising:
a mortise lock configured for mounting within a door cutout, the lock including an electrically powered device, a latch bolt assembly and a drive linkage coupling the electrically powered device to a lock linkage configured to, in a locked condition, lock a door lever or knob from actuating the latch bolt assembly from an extended neutral position, or to allow the door lever or knob to retract the latch bolt assembly to allow the door to open;
an electrical contact coupler system configured to transfer electrical power and control signals between the strike plate of a door frame to the electrically powered device;
a retraction linkage housed within the mortise lock which synchronizes the movement of the electrical contact coupler system with the latch bolt assembly's retraction, so that when the latch bolt assembly retracts, a contact coupler unit of the electrical contact coupler system follows suit, retracting into the mortise lock body; and
a strike plate electrical contact set disposed within a recess within the door frame and configured to make electrical contact with the electrical contact coupler system.

2. The lock system of claim 1, wherein the electrical contact set is connected to an access controller and power supply.

3. The lock system of claim 1 wherein the electrically powered device includes a motor.

4. The lock system of claim 1 wherein the electrically powered device includes a solenoid.

5. The lock system of claim 1, wherein the coupler unit is arranged to slide within a main housing, the coupler unit including a plurality of spring-loaded contact pins configured to contact the strike plate electrical contact set.

6. The lock system of claim 1, wherein the retraction linkage comprises a connection arm having a first end connected to the contact coupler unit and a second end connected to a latch rod comprising the latch bolt assembly, so that the contact coupler unit moves with the latch rod.

7. The lock system of claim 1, wherein the mortise lock includes a rotatable spindle configured to connect to an outdoor lever or knob, the spindle carrying a cog configured to engage and retract the latch bolt assembly, and the lock linkage include a tang which engages a recess on the spindle in the locked configuration.

8. An electrified mortise lock configured to receive electrical power through a door strike plate assembly, the lock comprising:
a mortise lock configured for mounting within a door cutout, the lock including an electrically powered device, a latch bolt assembly and a drive linkage coupling the electrically powered device to a lock linkage configured, in a locked condition, to lock a door lever or knob from actuating the latch bolt assembly from an extended neutral position to retract the latch bolt assembly to allow the door to open;
an electrical contact coupler system configured to transfer electrical power and control signals between the strike plate of a door frame to the electrically powered device; and
a retraction linkage housed within the mortise lock which synchronizes the movement of a contact coupler unit of the electrical contact coupler system with the latch bolt assembly's retraction, so that when the latch bolt assembly retracts, the contact coupler unit follows suit, retracting into the mortise lock body.

9. The mortise lock of claim 8, wherein the contact coupler unit is arranged to arranged to slide within a main housing, the contact coupler unit including a plurality of spring-loaded contact pins.

10. The mortise lock of claim 8, wherein the retraction linkage comprises a connection arm having a first end connected to the contact coupler unit and a second end connected to a latch rod comprising the latch bolt assembly, so that the contact coupler unit moves with the latch rod.

11. The mortise lock of claim 8, wherein the mortise lock includes a rotatable spindle configured to connect to an outdoor lever or knob, the spindle carrying a cog configured to engage and retract the latch bolt assembly, and the lock linkage include a tang which engages a recess on the spindle in the locked configuration.

12. The mortise lock of claim 8, wherein the coupler unit is arranged to slide within a main housing, the coupler unit including a plurality of spring-loaded contact pins.

13. The mortise lock of claim 8, wherein the retraction linkage comprises a connection arm having a first end connected to the contact coupler unit and a second end connected to a latch rod comprising the latch bolt assembly, so that the contact coupler unit moves with the latch rod.

14. The lock system of claim 8 wherein the electrically powered device includes a motor.

15. The lock system of claim 8 wherein the electrically powered device includes a solenoid.

16. A strike plate assembly for a door, the strike plate assembly comprising:
a strike plate having a latch bolt opening and an electrical contact opening formed therein;
a box configured to be assembled to the strike plate in a sandwiched position on the door frame, and having first and second receptacles, with the first receptacle configured to receive a latch bolt of a door, and the second receptacle fitted with electrical contact pads; and
wiring configured to connect the electrical contact pads to an access control power supply and an access controller.

17. The strike plate assembly of claim 16, further comprising a printed circuit board (PCB) holder which mounts a PCB carrying the electrical contact pads.
